(19) United States
(12) Patent Application Publication
(10) Pub. No.: US 2019/0297789 A1
(43) Pub. Date: Oct. 3, 2019

(54) STRUCTURES AND METHODS FOR SIMULTANEOUSLY GROWING PHOTOSYNTHETIC ORGANISMS AND HARVESTING SOLAR ENERGY

(71) Applicant: Brian von Herzen, Woods Hole, MA (US)

(72) Inventor: Brian von Herzen, Woods Hole, MA (US)

(21) Appl. No.: 16/368,807

(22) Filed: Mar. 28, 2019

Related U.S. Application Data
(60) Provisional application No. 62/649,516, filed on Mar. 28, 2018.

(51) Int. Cl. A01G 9/24; H02S 20/23; H02S 40/38; F24S 23/00

(52) U.S. Cl. CPC A01G 9/243; H02S 20/23; F24S 23/11; A01G 9/246; H02S 40/38

(57) ABSTRACT

A structure for growing plants and/or algae and for capturing solar energy is disclosed. The structure includes an enclosure having a roof and optionally one or more walls, a solar energy concentrator on at least part of the structure, an energy conversion device adjacent to at least one peripheral edge of the solar energy concentrator, and one or more supports or surfaces configured to enable the plants and/or algae to receive at least some of the solar energy. The solar energy concentrator absorbs or collects at least a first wavelength or wavelength band of light and allows at least a second wavelength or wavelength band of light different from the first wavelength or wavelength band of light to pass through (e.g., to the plants and/or algae). The solar energy concentrator comprises one or more absorbers or fluorophores selected from phycobiliproteins, fucoxanthins and luminescent molecules and materials. The energy conversion device is configured to receive and convert light emitted and/or collected by the solar energy concentrator to electrical or thermal energy. A method of growing plants and/or algae and for capturing solar energy using the same or similar structure is also disclosed.

### CROSS REFERENCE TO RELATED APPLICATION

This application claims the benefit of U.S. Provisional Patent Application No. 62/649,516, filed on Mar. 28, 2018, incorporated herein by reference as if fully set forth herein.

### FIELD OF THE INVENTION

The present invention relates to structures and methods for growing crops (or producing valuable chemicals and/or biological compounds and/or materials of interest) and harvesting solar energy.

### DISCUSSION OF THE BACKGROUND

Greenhouse crop production represents a significant and growing part of agriculture, especially for specialty crops and certain plants. The acreage devoted to greenhouse vegetable growing globally is estimated at 473,466 hectares (+14% in 2015). However, conventional greenhouses are energy intensive and expensive to light, heat or cool. Energy forms a substantial fraction of total production costs (15-30%) in at least some conventional greenhouses.

So-called “smart greenhouses” can also capture solar energy for electricity without necessarily reducing plant growth capabilities. For example, scientists from the University of California, Santa Cruz (UCSC) have shown that crops such as tomatoes and cucumbers can grow relatively normally in such “smart,” solar-powered greenhouses that capture solar energy for electricity.

Bright magenta panels cover the tops of the UCSC “smart” greenhouses, absorbing sunlight at a particular wavelength or wavelength band and transferring the energy to photovoltaic strips. The photovoltaic strips produce electricity. The greenhouses are able to take a certain portion of sunlight for energy and leave the rest, allowing plants to grow using a technology known as a Wavelength-Selective Photovoltaic System (WSPV). The technology may be less expensive and more efficient than traditional photovoltaic systems.

It has been reported that the growth and fruit production of 20 varieties of tomatoes, cucumbers, lemons, limes, peppers, strawberries and basil were tested at two or three locations in California. 80% of the plants were unaffected by the slightly darker lighting from the magenta panels, but 20% of the crops reportedly grew better. Tomato plants needed 5% less water under the magenta panels.

This “Discussion of the Background” section is provided for background information only. The statements in this “Discussion of the Background” are not an admission that the subject matter disclosed in this “Discussion of the Background” section constitutes prior art to the present disclosure, and no part of this “Discussion of the Background” section may be used as an admission that any part of this application, including this “Discussion of the Background” section, constitutes prior art to the present disclosure.

### SUMMARY OF THE INVENTION

The present invention relates to structures (e.g., buildings or other enclosures) adapted to produce multiple “crops,” continuously and/or intermittently during a predetermined time period (e.g., a calendar year or other time period comprising multiple growing seasons). The crops generally include food crops or plants from which valuable materials (such as certain biological compounds and other chemicals) can be obtained, electricity, and clean water. During the growing season, multiple food, plant or other biological crops can be grown in the same space within the structure. Thus, in some embodiments, the present invention concerns a fully productive greenhouse, configured to produce solar energy. For example, sunlight in the green wavelength band may be captured by a solar concentrator, and light in the red and blue wavelength bands may be utilized for greenhouse crop production. The light captured by the solar concentrator can produce electrical energy, which can be used in the greenhouse or sold for revenue. The revenue can, in turn, fund greenhouse production. Thus, the present invention increases climate resilience.

In one aspect, the present invention concerns a structure for growing plants and/or algae and for capturing solar energy, characterized in that the structure comprises an enclosure having a roof and optionally one or more walls, a solar energy concentrator on at least part of the structure, an energy conversion device adjacent to at least one peripheral edge of the solar energy concentrator, and one or more supports or surfaces configured to enable the plants and/or algae to receive at least some of the solar energy. The solar energy concentrator absorbs or collects at least a first wavelength or wavelength band of light and allows at least a second wavelength or wavelength band of light different from the first wavelength or wavelength band of light to pass through (e.g., to the plants and/or algae). The solar energy concentrator comprises one or more absorbers or fluorophores selected from phycobiliproteins, fucoxanthins and luminescent molecules and materials. The luminescent molecules and materials may be inorganic. The energy conversion device is configured to receive and convert light emitted and/or collected by the solar energy concentrator to electrical or thermal energy.

The structure may be characterized in that the energy conversion device comprises a plurality of photovoltaic (PV) cells configured to receive the light emitted or collected by the solar energy concentrator, and/or the solar energy concentrator absorbs the first wavelength or wavelength band of light and emits a third wavelength or wavelength band of light having longer wavelengths than the first wavelength or wavelength band of light. For example, the third wavelength or wavelength band may have a minimum wavelength longer than a maximum wavelength of the first wavelength or wavelength band. The third wavelength or wavelength band may be different from the second wavelength or wavelength band.

The structure may be further characterized in that the energy conversion device receives the light emitted by the solar energy concentrator and converts the received light to electrical energy. The solar energy concentrator may substantially cover the roof and may also be on or in at least one of the walls. Furthermore, the solar energy concentrator may have a major surface (i) facing the roof, (ii) parallel with the roof, or (iii) orthogonal or substantially orthogonal to the sunlight during at least part of the day (e.g., the solar energy concentrator may be configured to “track the sun”). The structure may be further characterized in that the energy conversion device surrounds one or more, two or more, or substantially all peripheral edges of the solar energy concentrator.

The structure may be characterized in that the one or more supports or surfaces are configured to enable the algae to receive the second wavelength or wavelength band of light. Alternatively, the structure may be characterized in that the support(s) or surface(s) may be configured to support one or more tanks of water, and the one or more tanks of water may be configured to grow water-based photosynthetic plants and/or algae. For example, the plants may implement photosynthesis using photo-system II (PS2) or water-plastoquinone oxidoreductase. The structure may be characterized in that the one or more supports or surfaces comprises a plurality of supports or surfaces that, taken together, enable the plants and/or algae to receive the second wavelength or wavelength band of light at the same time.

In some embodiments, the structure is characterized in that the solar energy concentrator is configured to absorb green light and allows at least blue light to pass through to the one or more supports or surfaces. In such embodiments, the solar energy concentrator may comprise (i) a luminescent compound or material that absorbs the green light and emits red light and (ii) one or more waveguides and/or reflectors configured to direct the red light to the energy conversion device (e.g., photovoltaic cells).

Alternatively, the structure may be characterized in that the solar energy concentrator is configured to absorb blue light and emit green light, the energy conversion device receives the green light and converts it to electrical energy, and the one or more supports or surfaces are configured to receive yellow and red light that pass through the solar energy concentrator.

The structure may be further characterized in that the structure further comprises (i) an energy storage and retrieval device or system configured to store and provide thermal energy converted by the energy conversion device and (ii) a mechanism for heating and/or cooling the structure using the thermal energy provided by the energy storage and retrieval device or system. The structure may also be further characterized in that the structure further comprises a battery configured to store and provide electrical energy converted by the energy conversion device. In some examples, the structure further comprises at least one water pump configured to receive the electrical energy from the battery and provide water to the plants and/or algae on the one or more supports or surfaces.

The structure may be characterized in that the absorber(s) or fluorophore(s) comprise one or more phycobiliproteins and/or organic fluorophores. The phycobiliprotein(s) and/or organic fluorophore(s) may be embedded in a polymer matrix and/or held in association with or bound by a binder molecule, and may be stable to UV radiation and/or thermally tolerant. The polymer matrix and/or binder molecule may increase the thermal stability of the phycobiliprotein and/or fluorophore across a temperature range wider than that of the (native) phycobiliprotein or fluorophore in the absence of the polymer or binder molecule. Thus, for example, the phycobiliprotein(s) and/or organic fluorophore(s) may be tolerant (e.g., to thermal energy) at a temperature of up to 40° C., 50° C., 60° C., 70° C., 80° C., 100° C., or higher. Additionally or alternatively, the structure may further comprise a photoabsorbent material that protects the phycobiliprotein or fluorophore and/or increases molecular stability of the phycobiliprotein or fluorophore in an environment containing ultraviolet or blue light. For example, the photoabsorbent material may comprise a UV-blocking glass that can protect the fluorophores from degradation by ultraviolet light.

The structure may be characterized in that the structure is configured for double or greater cropping (e.g., triple cropping, quadruple cropping, etc.). for example, the structure may further comprise a water desalinator, in which case one of the crops may be desalinated (e.g., fresh) water, and the structure may further comprise one or more conduits and one or more fresh water tanks or vessels in fluid communication with the one or more conduits, the one or more fresh water tanks or vessels being configured to store the desalinated water. In some examples, the water desalinator may comprise an evaporator configured to evaporate fresh water from a saline or a brine, and the structure may further comprise a condenser configured to condense the evaporated fresh water from the evaporator. The condenser may comprise a conduit or vessel including or in communication with a cold water source. The structure may be further configured to irrigate the plants and/or algae with the condensed fresh water.

Another aspect of the present invention concerns a method of growing plants and/or algae and for capturing solar energy, characterized in that the method comprises absorbing or collecting at least a first wavelength or wavelength band of light using a solar energy concentrator on at least part of a roof of an enclosure having the roof and a plurality of walls, allowing at least a second wavelength or wavelength band of light different from the first wavelength or wavelength band of light to pass through the solar energy concentrator, receiving light emitted or collected by the solar energy concentrator in an energy conversion device adjacent to at least one peripheral edge of the solar energy concentrator, converting the light emitted or collected by the solar energy concentrator to electrical or thermal energy using the energy conversion device, and irradiating plants and/or algae on one or more supports or surfaces in the enclosure with the second wavelength or wavelength band of light. The solar energy concentrator comprises one or more absorbers selected from phycobiliproteins, fucoxanthins and luminescent inorganic molecules and materials.

As with the present structure, the method may be characterized in that the energy conversion device comprises a plurality of photovoltaic (PV) cells configured to receive the light emitted or collected by the solar energy concentrator. The method may be characterized in that the method further comprises absorbing the first wavelength or wavelength band of light with the solar energy concentrator and emitting a third wavelength or wavelength band of light having a longer wavelength than the first wavelength or wavelength band of light from the solar energy concentrator, in which case the method may further comprise receiving the light emitted by the solar energy concentrator in the energy conversion device and converting the received light to electrical energy using the energy conversion device. The third wavelength or wavelength band of light may be different from the second wavelength or wavelength band of light.

The present method may be characterized in that the solar energy concentrator substantially covers the roof of the enclosure and may also be on or in at least one of the walls. As for the present structure, the solar energy concentrator may have a major surface (i) facing the roof, (ii) parallel with the roof, or (iii) orthogonal or substantially orthogonal to the sunlight during at least part of the day. The method may be characterized in that energy conversion device surrounds one or more, two or more, or substantially all peripheral edges of the solar energy concentrator.

The method may be characterized in that the algae receive the second wavelength or wavelength band of light, and the one or more supports or surfaces may be configured to enable the algae receive the second wavelength or wavelength band of light. Alternatively or additionally, the method may be characterized in that the support(s) or surface(s) are configured to support one or more tanks of water, and the method may further comprise growing water-based photosynthetic plants in the one or more tanks of water. For example, the plants may implement photosynthesis using photo-system II (PS2) or water-plastoquinone oxidoreductase. The method may also be characterized in that the one or more supports or surfaces comprise a plurality of supports or surfaces that, taken together, enable the plants and/or algae to receive the second wavelength or wavelength band of light at the same time.

The present method may be characterized in that the method comprises absorbing green light in the solar energy concentrator and allowing at least blue light to pass through to the one or more supports or surfaces. Alternatively, the method may be characterized in that the method comprises absorbing blue light in the solar energy concentrator and emitting green light from the solar energy concentrator, receiving and converting the green light to electrical energy in the energy conversion device, and receiving yellow and red light that pass through the solar energy concentrator in the plants and/or algae on the one or more supports or surfaces.

The present method may be characterized in that the method further comprises storing thermal energy converted by the energy conversion device in an energy storage and retrieval device or system, retrieving the thermal energy from the energy storage and retrieval device or system, and/or heating and/or cooling the enclosure (or a part thereof) using the thermal energy from the energy storage and retrieval device or system. Alternatively or additionally, the method may be characterized in that the method further comprises storing electrical energy converted by the energy conversion device in a battery and providing the electrical energy from the battery to an electrical device in the enclosure and/or to an electrical transmission medium external to the enclosure. For example, the method may be characterized in that the method further comprises providing water to the plants and/or algae on the one or more supports or surfaces using at least one water pump configured to receive the electrical energy from the battery.

The present method may be characterized in that the absorber(s) comprise one or more phycobiliproteins, in which case the one or more phycobiliproteins may be embedded in a polymer matrix. As for the present structure, the one or more phycobiliproteins may be stable to UV radiation and/or thermally tolerant. For example, during the method, a temperature of the solar energy concentrator and/or the polymer matrix may reach 40° C., 50° C., 60° C., 70° C., 80° C., 100° C., or higher, and the phycobiliprotein(s) should be tolerant of (e.g., retain its activity at) one or more such temperatures.

The method may be characterized in that the method further comprises growing a first crop in a first growing season, and growing at least a second crop in a second growing season, an entirety of the first and second growing seasons occurring within a time period of twelve consecutive months. The method may be further characterized in that the method further comprises growing a third crop in a third growing season, the entirety of the first, second and third growing seasons occurring within the twelve consecutive months.

In further embodiments, the method may be characterized in that the method further comprises desalinating a saline solution or a brine using a water desalinator. In such embodiments, the method may be further characterized in that the method further comprises transporting fresh water from the water desalinator to the plants and/or algae, or storing the fresh water from the water desalinator in one or more fresh water tanks or vessels. Alternatively or additionally, the method may be further characterized in that the method further comprises evaporating the fresh water from the saline solution or the brine in an evaporator in the water desalinator, and condensing the fresh water from the evaporator in a condenser. Such methods may be further characterized in that the method further comprises cooling the condenser using a cold water source and/or irrigating the plants and/or algae with the condensed fresh water.

In accordance with embodiments of the present invention, structures and methods for triple, quadruple or greater cropping are provided. The invention further provides a fully productive greenhouse that is also capable of solar-based production of electrical or thermal energy. The present greenhouse can be used for year-round crop growth and production of solar energy. In some embodiments, the present greenhouse effectively doubles the revenue per acre (relative to conventional soil-based farming), reduces the cost of growing the crops, and uses up to 10 times less water than conventional soil-based farming. The present greenhouse can extend farmers' revenue streams (e.g., the photovoltaic energy production can fund part or all of the greenhouse activities and/or operations). These and other advantages of the present invention will become readily apparent from the detailed description of various embodiments below.

### BRIEF DESCRIPTION OF THE DRAWINGS

FIG. 1 is a is a greenhouse (or more accurately, a “magenta” house);

FIG. 2A is a graph showing the visible light absorption spectra of various chlorophylls;

FIG. 2B is a graph showing the visible light absorption spectra of various phycobiliproteins compared to chlorophylls A and B;

FIG. 3 is an exploded view of the layers of a luminescent dye-based solar energy collector;

FIG. 4A depicts various photosystem II cycles;

FIG. 4B depicts the photosystem II photosynthetic complex;

FIG. 5 is a diagram of an exemplary luminous solar concentrator;

FIG. 6 is a diagram showing operation(s) of an exemplary luminous solar concentrator in accordance with embodiments of the invention;

FIG. 7 is a schematic diagram showing an exemplary evaporative greenhouse adapted/configured for quadruple cropping in accordance with embodiments of the invention;

FIG. 8 is a diagram showing an exemplary structure adapted/configured for quadruple cropping in accordance with embodiments of the invention; and

FIG. 9 is a flow chart of an exemplary method of simultaneously generating electricity and growing crops in accordance with embodiments of the invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, variations that are not inconsistent may be mixed and matched as desired.

For the sake of convenience and simplicity, the terms “part,” “portion,” and “region” may be used interchangeably, but these terms are generally given their art-recognized meanings. Also, unless indicated otherwise from the context of its use herein, the terms “known,” “fixed,” “given,” “certain” and “predetermined” generally refer to a value, quantity, parameter, constraint, condition, state, process, procedure, method, practice, or combination thereof that is, in theory, variable, but is typically set in advance and not varied thereafter when in use.

FIG. 1 depicts an exemplary greenhouse 100 adapted for quadruple cropping in accordance with one or more embodiments of the present invention. The term “quadruple cropping” refers to an ability to grow crops during three seasons in a year (e.g., a 12-month consecutive period of time), plus harvest solar energy during that period. Alternatively, quadruple cropping may refer to an ability to grow crops during two seasons in a year, plus harvest solar energy and produce fresh water during that period. The term “quintuple cropping” may refer to an ability to grow crops during three seasons in a year, plus harvest solar energy and produce fresh water during that period. A greenhouse or other structure capable of quadruple or quintuple cropping can produce at least double the revenue per acre relative to most farms on Earth, using 10 times less water. Thus, production of the crops is less expensive, and farmers' revenue streams can be extended (e.g., to additional crops and/or by selling excess electricity and/or water).

The structure 100 includes roof panels 110, walls 140, a front panel 130, a rear panel (not shown), one or more doors 135, and optional front and rear gables 120. The roof panels 110 generally include a solar collector (e.g., a luminescent solar collector, or LSC). At least one roof panel 110 (and preferably at least half of the roof panels 110) include a solar collector. In some embodiments, the walls 140, the front panel 130 and/or the rear panel also include a solar collector, depending on their orientation towards the sun. For example, a structure 100 located in the Northern Hemisphere and having doors facing east or west may include one or more solar collectors in or on the south-facing wall.

Even the combinations of double or triple cropping and evaporative greenhouses (e.g., greenhouses adapted to collect and optionally use evaporated water) enable use of a water source that is not typically used to irrigate crops, such as sea water or waste water, and are therefore novel combinations. Evaporative greenhouses can therefore include structures and/or equipment for water desalination and have the ability to desalinate saline or brine (e.g., water containing one or more salts) and use the desalinated water for irrigation and/or cooling.

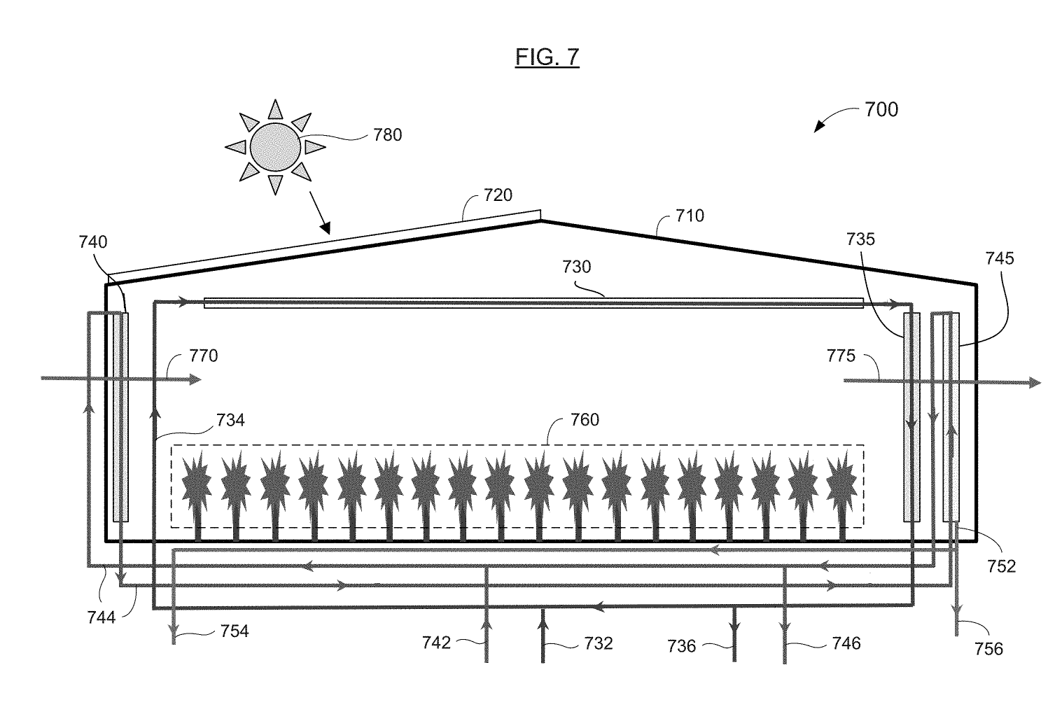

For example, referring now to FIG. 7, which shows a schematic for an exemplary evaporative greenhouse 700, cold brine input into first and second water circuits at inlets 732 and 742 may form the cold (or condensing) part of a heat exchanger on the “exhaust side” (i.e., where exhaust air 775 flows out) of the evaporative greenhouse 700. The brine may be transported from deep sea water (e.g., water from a depth of ≥300 m, ≥500 m or any other minimum depth more than 300 m below sea level) or may come from another source (e.g., chemical manufacturing, water purification, fermentation or other biological production processes, food processing, mining, pulp and paper making, etc.). Pipes 734 transporting the saline or brine to an evaporator 735 may be run through a solar heater 730 in the ceiling of the greenhouse 700 or other similar structure (e.g., just below the roof panels 710), in part to limit sunlight in high-sunlight regions (such as the desert) to the plants 760, and also to absorb more solar heat or other energy in the roof 710 (below the solar collector panels 720). Thereafter, the brine or other water-based liquid, now warmed, goes to an evaporative medium (e.g., the evaporator 735, which may comprise a porous medium), through which air 775 is drawn by one or more exhaust fans (not shown). The air 775 passes through the evaporative medium 735, collecting water vapor (e.g., absorbing evaporated water molecules) and potentially cooling the air. Downstream from the fan, the water vapor (now a source of fresh water) condenses in/on a condenser 745. With a cold water source (e.g., the cold brine injected at inlet 742 that eventually flows to the condenser 745), the evaporated water can be condensed on the exhaust side of the greenhouse 700. The condensate may be collected in one or more pipes 752 as fresh water for use as irrigation water for drip irrigation and/or misting of plants (e.g., at 754 and/or 756). Alternatively, the fresh water may be simply collected and sold or used for other purposes. The saltier brine leaves the evaporator 735 through outlet 736 (and then the greenhouse 700) and can be used for salt production, etc.

Pipes 744 carry the brine from the inlet 742 to a second evaporator 740, through which warm outside air 770 passes. The air 770 transfers heat to the brine, the air 770 absorbing some water vapor and cooling in the process. The slightly warmer and slightly more concentrated brine then flows to the condenser 745, where it warms a little more before exiting the water circuit (and thus the greenhouse 700) at outlet 746. If desired, some (or all) of the brine from the condenser 745 may be recirculated back to the evaporator 740 (e.g., using one or more valves and pumps, not shown).

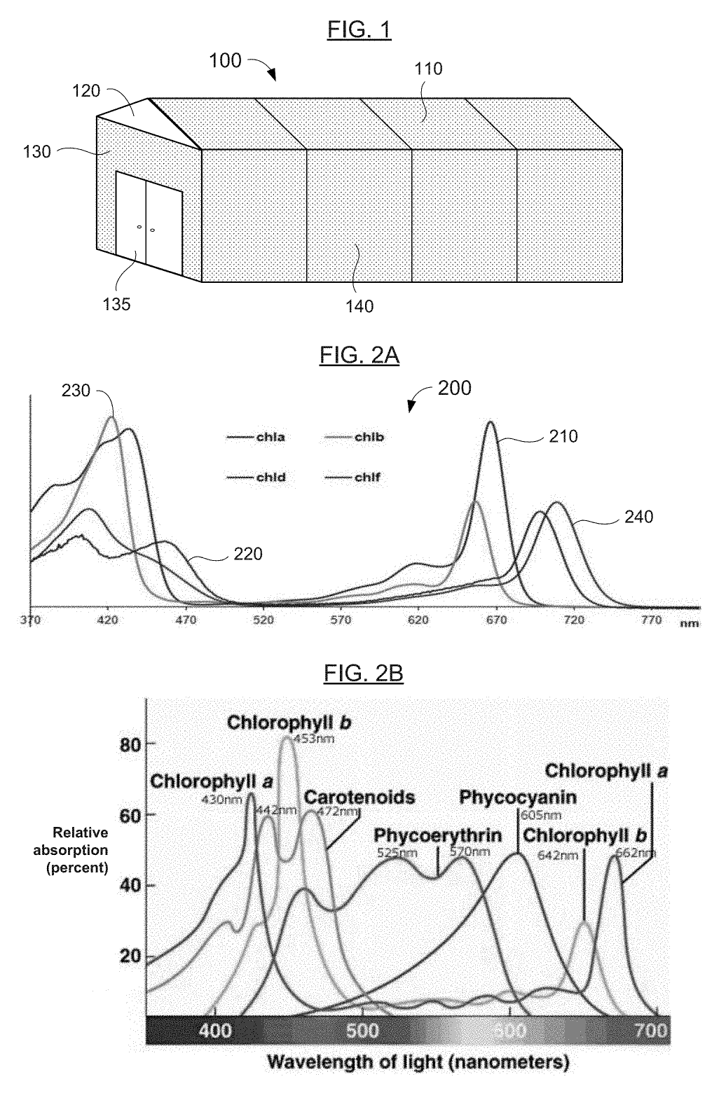

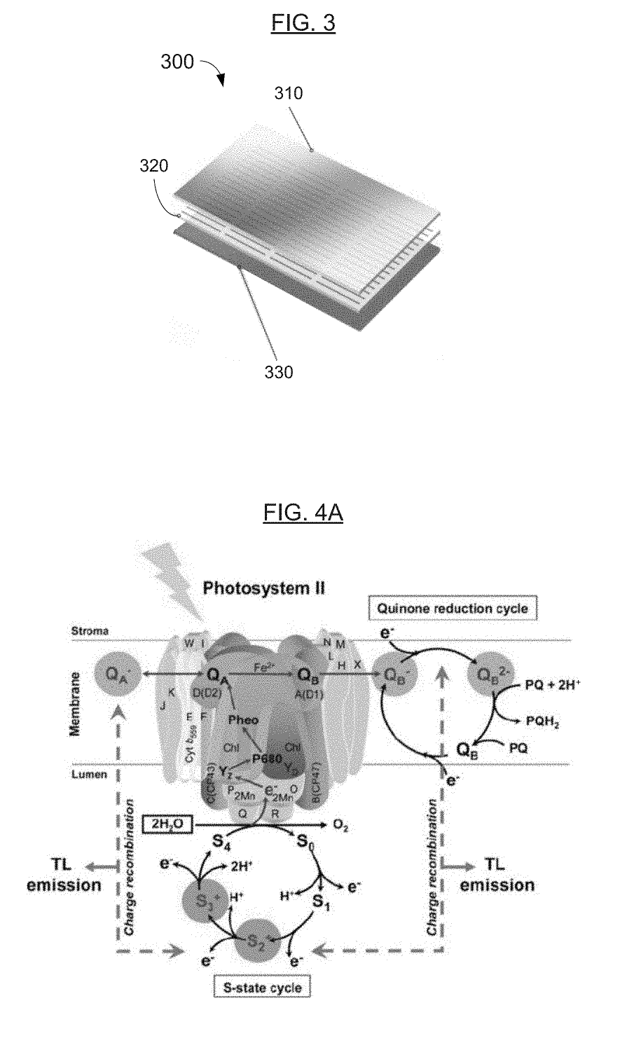

FIG. 2A is a graph 200 showing the visible light absorption spectra of various chlorophylls. For example, the visible light absorption spectra of chlorophyll a is shown by line 210, the visible light absorption spectra of chlorophyll d is shown by line 220, the visible light absorption spectra of chlorophyll b is shown by line 230, and the visible light absorption spectra of chlorophyll f is shown by line 240. The various chlorophylls do not absorb significantly in the range 470-630 nm, meaning that light in this bad can be used for other purpose (e.g., electricity generation, energy storage, etc.).

Phycobiliproteins are photodynamic proteins that can drive photosynthesis and function as light receptors. For example, phycoerythrin shows a very strong fluorescence (e.g., in the red band of the visible spectrum). A wide variety of phycobiliproteins can be made from a fairly well-characterized source. For example, cyanobacteria make phycobilisomes, each containing ˜1,500 pigments. Markets for phycobiliproteins include cosmetics, fluorescent markers, dyes and biomaterials.

FIG. 2B is a graph showing the visible light absorption spectra of various phycobiliproteins compared to chlorophylls A and B. In the present structure and method, the solar collector advantageously uses phycobiliproteins (PBPs) to absorb light in wavelength bands not used by chlorophylls and/or other photosynthetic plants and algae (e.g., that use photosystem II for photosynthesis). The PBP(s) can emit light (generally having a different wavelength) to an energy conversion device adjacent to at least one peripheral edge of the solar energy concentrator (e.g., along a peripheral edge of a roof panel 110, at an interface between a roof panel 110 and a wall 140, etc.). The light not absorbed by the PBP(s) passes through the roof panels 110 into the structure 100, which can include one or more supports or surfaces configured to enable plants and/or algae to receive the light passing through the roof panels 110. The crops can therefore comprise the plants, and the algae can be used to make beneficial chemicals and biological compounds and materials that can be collected using known techniques.

The PBP(s) can be made UV stable and thermally tolerant by embedding them in a polymer matrix (e.g., a polymer film). UV protection can also be provided with a UV blocking glass above the polymer matrix, or another type or kind of composite UV film and/or filter can be used. The films, including the PBP-containing polymer film, can be adhered to the glass. Alternatively, the absorber(s) and/or fluorophore(s) may be combined (e.g., mixed) with one or more tardigrade proteins. Tardigrades can survive in outer space environments (e.g., on the surface of spacecraft), so they are hardy across a variety of thermal, oxygen- and water-free, and UV environments. Their proteins, including tardigrade-specific intrinsically disordered proteins (TDPs) and/or a protein known as Dsup, are known to protect tardigrades from desiccation and may even protect the animals' nucleic acids from damage and/or stress caused by high-energy radiation (e.g., X-rays). Tardigrade proteins can also increase the thermal and photochemical stability of the absorber(s) and/or fluorophore(s) that might otherwise degrade at high temperature and/or under the stress of UV light.

Photosynthetic efficiency is a useful factor to understand the potential utilities of phycobiliproteins. For example, land-based plants typically have a photosynthetic efficiency of 0.2-2% (e.g., as exemplified by the photosynthetic efficiencies of chlorophylls a and b), whereas some water-based plants can have a photosynthetic efficiency exceeding 8% (e.g., as exemplified by the photosynthetic efficiency of the phycobiliprotein B-phycoerythrin from red algae).

The potential revenue of products made from or including phycobiliproteins is quite high. For example, in the fluorescent marker market, calculations show that certain seaweeds under replete nitrate conditions can contain up to 0.05% phycoerythrin (PE) by fresh weight. PE is valued at up to US$300/mg. That corresponds to US$15M/ton fresh weight. The market for PE will be US$4B in 2022, and possibly larger as the market(s) grow.

FIG. 3 is an exploded view of the layers of a luminescent dye-based solar energy collector 300, which may include a glass layer, sheet or plate 310 (which can be UV protective), the luminescent (e.g., phycobiliprotein-containing) layer 320, and a reflective support layer, film or sheet 330, which can direct the emitted light (using total internal reflection) to the energy conversion device (e.g., a photovoltaic [PV] cell). Alternatively, the layer 320 may comprise a matrix of PV cells configured to generate electricity from light having a predetermined wavelength or wavelength band (which may overlap with the wavelengths or wavelength bands of light used by plants and algae for photosynthesis), and the layer 330 may be the luminescent (e.g., phycobiliprotein-containing) layer, which can emit light having a wavelength or wavelength band useful for photosynthesis in plants and/or algae. In a further alternative, the layer 330 may be the luminescent (e.g., phycobiliprotein-containing) layer, and the layer 320 can be a light-collecting layer that focuses the emitted light to the PV cells on the periphery of the collector 300. An example of the luminescent solar energy collector 300 may be found in U.S. Pat. Appl. Publ. No. 2012/0132278, the relevant portions of which are incorporated herein by reference.

FIG. 4A depicts various photosystem II cycles, including the quinone reduction cycle and the S-state cycle. In photosystem II, enzymes capture photons of light to energize electrons that are then transferred through a variety of coenzymes and cofactors to reduce plastoquinone to plastoquinol. The energized electrons are replaced by electrons from water, which oxidizes to form hydrogen ions and molecular oxygen. By replenishing lost electrons with electrons from the splitting of water, photosystem II provides the electrons for all of photosynthesis to occur. Photosystem II (of cyanobacteria and green plants) generally contains around 20 subunits (depending on the organism) as well as other accessory, light-harvesting proteins. Each photosystem II contains one or more chlorophyll a units 440, beta-carotene, pheophytin, plastoquinone, one or more hemes, one or more bicarbonate ions, lipids 450, a Mn—Ca oxide cluster (which may include chloride ions), a non-heme Fe²⁺ ion and possibly Ca²⁺ ions. FIG. 4B depicts the phycobilisome mega-complex 400. Elements 410, 420 and 430 identify components of the phycobilisome, including phycocyanin and phycoerythrin.

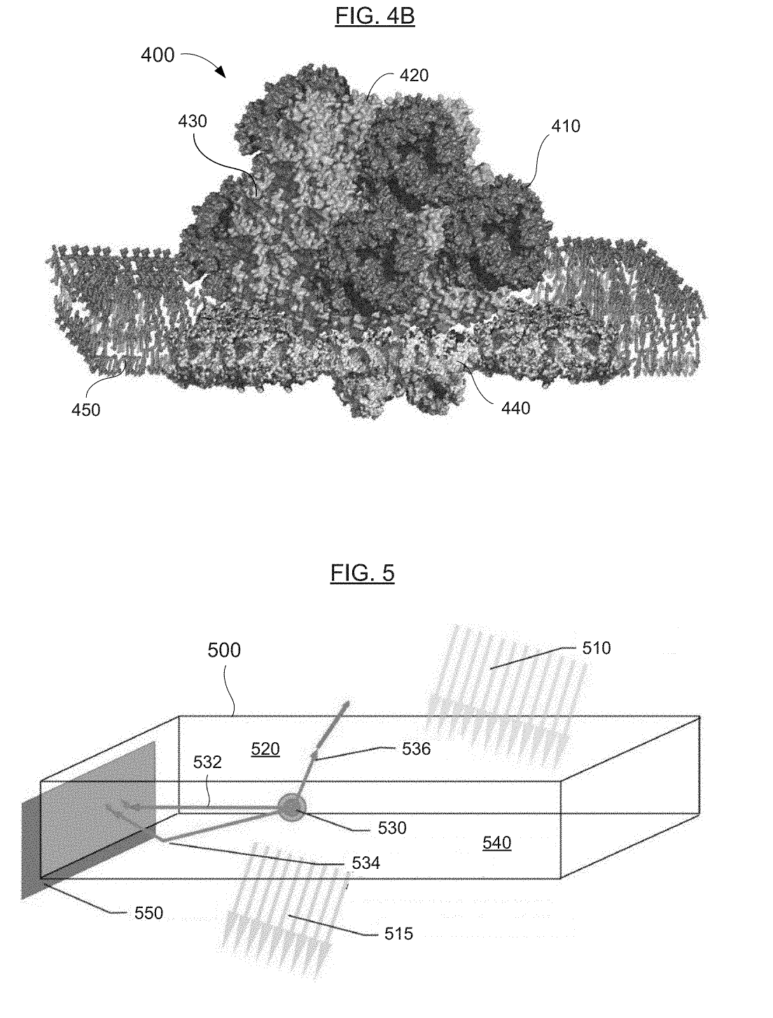

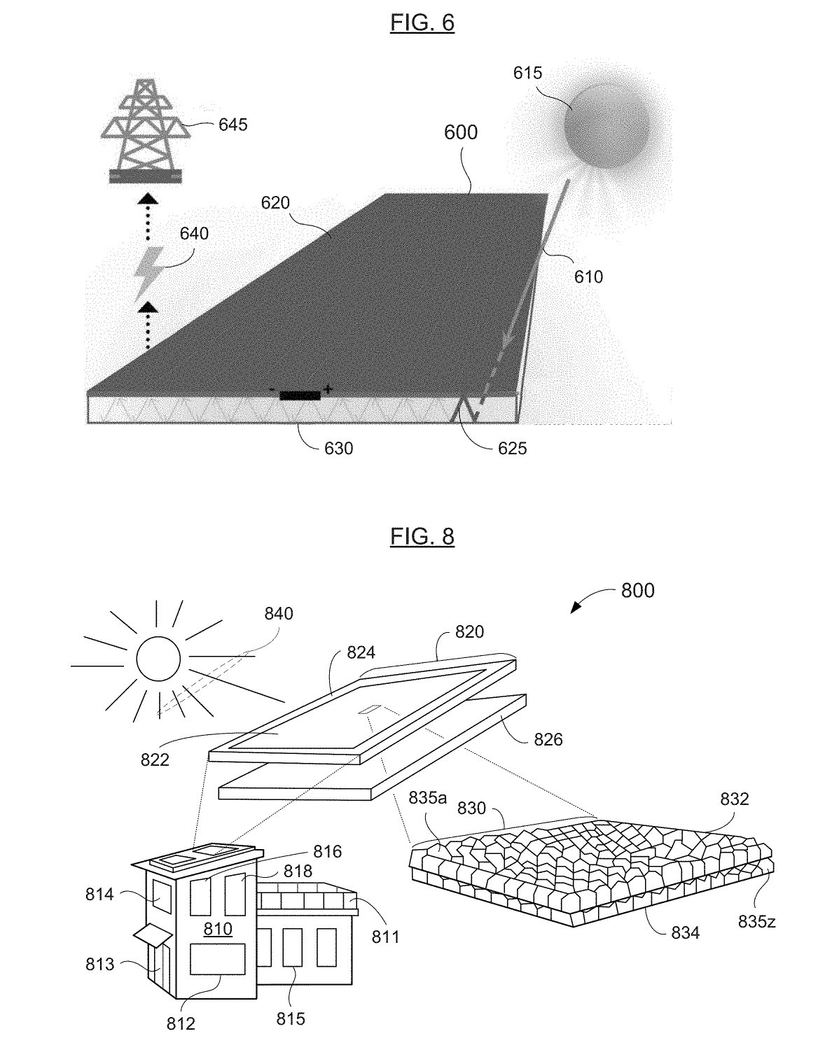

FIG. 5 is a diagram of an exemplary luminous solar concentrator 500 that can be implemented in or by the solar energy collector 300 in FIG. 3. Incident rays 510 from the sun can impinge on the solar concentrator 500 and pass through a cover or uppermost layer 520 of the solar concentrator 500. The cover 520 may comprise a glass or plastic that is transparent to visible light and that may absorb or reflect ultraviolet (UV) light. A plurality of luminescent centers 530 (only one of which is show for clarity purposes) are present throughout the solar concentrator 500. For example, in a horizontal cross-section of the solar concentrator 500, the luminescent centers 530 are present in substantially the entirety of the area or major surface thereof (e.g., other than the periphery and any waveguides that may be present). The luminescent centers 530 can be or comprise a phycobiliprotein (e.g., in a polymer matrix), a fucoxanthin or a luminescent inorganic molecule or material. Thus, the luminescent centers 530 may absorb a particular wavelength or wavelength band of solar radiation and emit light having a different (and typically longer) wavelength or wavelength band. In preferred embodiments, the luminescent centers 530 are embedded in a polymer matrix and are protected from damage (e.g., denaturation) by or from the sun and/or heat, as described herein.

The light emitted from the luminescent centers 530 may be absorbed by an energy conversion device 550 either directly (e.g., by direct emissions 532) or indirectly (e.g., by reflected emissions 534). The solar concentrator 500 may therefore include a lower layer or underside coating 540 (e.g., a wavelength-selective mirror) that reflects light having the wavelength or wavelength band of the light emitted by the luminescent centers 530, but is transparent or substantially transparent to light having other wavelengths or wavelength bands. For example, the lower layer or underside coating 540 may completely or substantially completely reflect one wavelength or wavelength band of visible light, and be transparent or substantially transparent to some or all other wavelengths or wavelength bands of visible light. Some emitted light 536 may escape the solar concentrator 500 through the cover or uppermost layer 520. To allow the maximum intensity of the incident rays 510 having the same wavelength or wavelength band as the light emitted from the luminescent centers 530, the cover or uppermost layer 520 may not include a wavelength-selective mirror. Alternatively, if the intensity of the emissions from the luminescent centers 530 is greater than that of solar radiation at the same wavelength or wavelength band, the cover or uppermost layer 520 may include a wavelength-selective mirror configured to reflect light having a wavelength within the wavelength band of light emitted from the luminescent centers 530.

The energy conversion device 550 may comprise one or more photovoltaic (PV) cells (e.g., for converting the received light to electricity) or a photoabsorbent material in thermal contact or communication with a heat exchanger that transfers heat to a working fluid for storage in a heat storage tank or vessel. For example, the photoabsorbent material may be configured to absorb light having the wavelength or wavelength band of the light emitted by the luminescent centers 530, convert the absorbed light to heat, and transfer the heat through the heat exchanger to the working fluid (e.g., a gas or liquid, such as water, a brine or saline solution, a glycol [e.g., ethylene glycol, propylene glycol, glycerol, etc.] or a mixture thereof with water, a molten salt, etc.). The heated working fluid may be transported by one or more insulated conduits to a storage vessel. The heated working fluid can be retrieved from the storage vessel and used to heat the greenhouse or generate another form of energy (e.g., electricity) by a known process or method.

Light 515 that is not absorbed by the luminescent centers 530, reflected by the lower layer or underside coating 540, absorbed by the energy conversion device 550, or emitted through the cover or uppermost layer 520 is transmitted through the lower layer or underside coating 540 to plants or algae (not shown in FIG. 5). Optionally, when the energy conversion device 550 comprises one or more PV cells, some of the transmitted light may be absorbed by a solar heater (e.g., the solar heater 730 in FIG. 7).

FIG. 6 is a diagram showing operation(s) of an exemplary luminous solar concentrator 600 in accordance with embodiments of the invention. Light 610 from the sun 615 impinges on the luminescent layer 620 of the solar concentrator 600. Light having a first wavelength or color (e.g., green light) is absorbed by a luminescent material or substance in the luminescent layer 620, which then emits light having a second wavelength or color (e.g., red light 625). The red light 625 is reflected by a lower layer or coating 630 configured to selectively reflect red light and is received by one or more PV cells (not shown) along the peripheral edge(s) of the solar concentrator 600. Other wavelengths or colors of light (e.g., blue, green, yellow, violet, orange) pass through the lower layer or coating 630. The red light received by the PV cell(s) is converted into electricity 640 and, in this example, sold to a municipal, state, regional or private electric utility and passed onto an electrical grid 645. In one embodiment, the luminous solar concentrator 600 may be or comprise a LUMO panel available commercially from Soliculture, Scotts Valley, Calif.

FIG. 8 is a diagram showing an exemplary structure 810 adapted/configured for a quadruple cropping system 800 in accordance with embodiments of the invention. The structure 810 may comprise a house or smart greenhouse having a plurality of windows 812, 814, 815, 816 and 818, and one or more solar collector panels 820 having one or more PV cells along a periphery 824 thereof or in a layer (e.g., 822) thereof. Sunlight 840 irradiates the solar collector panels 820. Green light is captured by the solar concentrators 820 (e.g., in a photoluminescent layer 830 comprising a plurality of photoluminescent species 835a-z randomly or directionally oriented in a matrix configured to support and/or orient photoluminescent species 835a-z), and light (e.g., light emitted from the photoluminescent species 835a-z) for generating electricity is directed to the PV cells as described herein. The photoluminescent layer 830 may comprise a plurality of photoluminescent sub-layers 832, 834. At least the lowermost photoluminescent sub-layer 834 (and, in one embodiment, each of the photoluminescent sub-layers) has a wavelength-selective mirror or coating on an underside thereof, configured to reflect the light emitted from the photoluminescent species 835a-z towards the PV cell(s). Different colors or wavelengths of light (e.g., red and blue light) passing through the lowermost layer or backside cover 826 of the solar collector panels 820 (some of which may have been generated by the solar collector panels 820) is utilized for greenhouse crop production. In addition to revenue from crops, the revenue from producing electricity can further fund greenhouse production, increasing climate resilience.

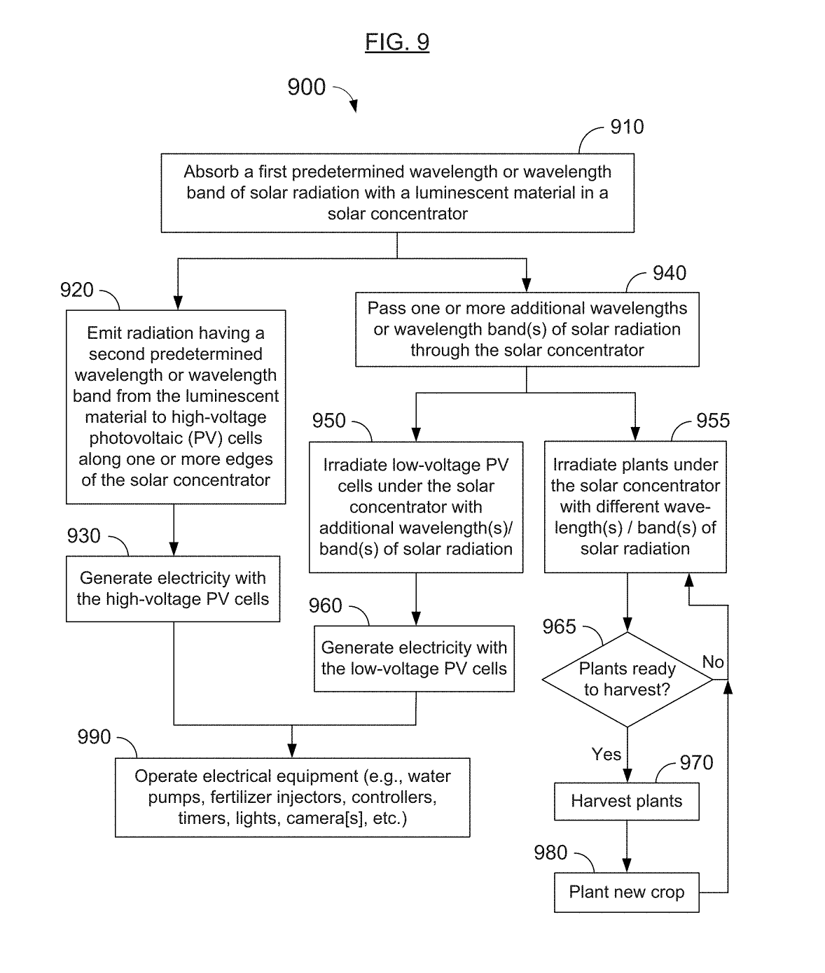

FIG. 9 is a flow chart 900 of an exemplary method of simultaneously generating electricity and growing crops in accordance with embodiments of the invention. At 910, a first predetermined wavelength or wavelength band of solar radiation (e.g., green, violet or UV light) is absorbed with a luminescent material (e.g., a phycobiliprotein or a dye) in a solar concentrator, as described herein. Then, at 920, the luminescent material in the solar concentrator emits radiation having a second predetermined wavelength or in a second predetermined wavelength band to one or more high-voltage photovoltaic (PV) cells along one or more edges of the solar concentrator. Alternatively, the emitted radiation may be received by a material or substance configured to convert the emitted radiation to heat and transfer the heat to a heat storage medium (e.g., the working fluid described herein). In some embodiments, the method may further comprise reflecting or otherwise directing at least some of the emitted radiation to the PV cells or radiation-absorbing material or substance.

The second predetermined wavelength or wavelength band of radiation is generally longer than the first predetermined wavelength or wavelength band of radiation. For example, when the luminescent material absorbs ultraviolet light, the luminescent material may emit light in any band or having any wavelength in the visible spectrum. When the luminescent material absorbs violet light, the luminescent material may emit light having a longer wavelength or a different color (e.g., green light). Similarly, when the luminescent material absorbs green light, may emit light in a longer wavelength band or having a longer wavelength (e.g., red light).

In parallel with 920-930, one or more additional wavelengths or wavelength band(s) of solar radiation may pass through the solar concentrator at 940, as described herein. The additional wavelengths or wavelength band(s) of solar radiation can have multiple uses. For example, at 950, low-voltage PV cells under the solar concentrator may be irradiated with the additional wavelength(s) and/or band(s) of solar radiation. For example, the low-voltage PV cells may be configured to absorb and convert yellow and/or orange light to electricity at 960. Alternatively, a solar heater (e.g., as described herein) under the solar concentrator may be irradiated with the additional wavelength(s) and/or band(s) of solar radiation. The solar heater can be used in a process for desalinization of brine or salt water, as described herein. At 955, plants and/or algae under the solar concentrator may be irradiated with different wavelengths and/or wavelength bands of solar radiation (e.g., red and/or blue light), as described herein.

At 965, one determines whether the plants or algae are ready to harvest. Typically, a farmer or crop scientist determines whether plants are ready to harvest, and a technician, biologist or phycologist determines whether algae are ready to harvest. There may be one or more standard criteria for such determinations. For example, plants may have a certain minimum size or bear fruit or other crops having a certain minimum size or color. Algae may produce a certain minimum concentration of a desired substance or compound.

When the harvesting criterion or criteria is/are met or the determination to harvest is otherwise made (e.g., a certain time period has elapsed since growth of the plants or algae was initiated), the plans or algae are harvested at 970, and a new crop of plants or algae are started (e.g., planted or placed in tanks and/or on supports under the solar collector[s]) at 980. Typically, a minimum of two or three cycles of plant/algae growth and harvesting from start to finish will take place within a year (e.g., a period of 12 consecutive calendar months).

In parallel with irradiating the plants or algae at 955, harvesting the plants or algae at 970, and starting a new crop at 980, the electricity generated at 930 and 960 can be used to operate electrical equipment in the greenhouse at 990. For example, one or more water pumps, fertilizer injectors, controllers, timers, lights, cameras, etc., in the greenhouse can be operated using the electricity generated at 930 and 960. Alternatively or additionally, when the method 900 includes desalinization of brine or salt water, the fresh water produced by the method can also be used in the greenhouse to water the crops (e.g., at 955). In further alternatives, the electricity and/or fresh water can be sold (e.g., to a municipal, state, regional or private electricity or water provider).

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

1. A structure for growing plants and/or algae and for capturing solar energy, characterized in that the structure comprises:
a) a structure having at least a roof and optionally one or more walls;
b) a solar energy concentrator on at least part of the structure, the solar energy concentrator absorbing or collecting at least a first wavelength or wavelength band of light and allowing at least a second wavelength or wavelength band of light different from the first wavelength or wavelength band of light to pass through, the solar energy concentrator comprising one or more fluorophores selected from phycobiliproteins, fucoxanthins and luminescent molecules and materials therein or thereon;
c) an energy conversion device adjacent to at least one peripheral edge of the solar energy concentrator, the energy conversion device being configured to receive and convert light emitted or collected by the solar energy concentrator to electrical or thermal energy; and
d) one or more supports or surfaces configured to enable the plants and/or algae to receive the second wavelength or wavelength band of light.

2. The structure of claim 1, characterized in that said energy conversion device comprises a plurality of photovoltaic (PV) cells configured to receive the light emitted or collected by the solar energy concentrator.

3. The structure of claim 1, characterized in that the solar energy concentrator absorbs the first wavelength or wavelength band of light and emits a third wavelength or wavelength band of light having a longer wavelength than the first wavelength or wavelength band of light.

4. The structure of claim 3, characterized in that the energy conversion device receives the light emitted by the solar energy concentrator and converts the received light to electrical energy.

5. (canceled)

6. The structure of claim 1, comprising the one or more walls, characterized in that the solar energy concentrator is also on or in the at least one of the one or more walls.

7-15. (canceled)

16. The structure of claim 1, characterized in that the structure further comprises an energy storage and retrieval device or system configured to store and provide thermal energy converted by the energy conversion device, and a mechanism for heating and/or cooling the structure using the thermal energy provided by the energy storage and retrieval device or system.

17. (canceled)

18. The structure of claim 1, characterized in that the structure further comprises at least one water pump configured to receive electrical energy from the structure and provide water to the plants and/or algae on the one or more supports or surfaces.

19. The structure of claim 1, characterized in that said one or more fluorophores comprise one or more organic fluorophores.

20. The structure of claim 19, characterized in that said one or more organic fluorophores is/are embedded in a polymer matrix.

21. (canceled)

22. (canceled)

23. The structure of claim 1, characterized in that said structure is configured for double or greater cropping, and said structure further comprises a swamp cooler.

24-28. (canceled)

29. The structure of claim 19, further comprising a binder molecule that holds or binds the fluorophore and increases thermal stability of the fluorophore across a temperature range wider than that of the fluorophore without the binder molecule.

30. The structure of claim 19, further comprising a photoabsorbent material that protects the fluorophore and increases molecular stability of the fluorophore in an environment containing ultraviolet or blue light.

31. A method of growing plants and/or algae and for capturing solar energy, characterized in that the method comprises:
a) absorbing or collecting at least a first wavelength or wavelength band of light using a solar energy concentrator on at least part of a structure, the structure having at least a roof and optionally one or more walls, the solar energy concentrator comprising one or more absorbers or fluorophores selected from phycobiliproteins, fucoxanthins and luminescent molecules and materials therein or thereon;
b) allowing at least a second wavelength or wavelength band of light different from the first wavelength or wavelength band of light to pass through the solar energy concentrator;
c) receiving light emitted or collected by the solar energy concentrator in an energy conversion device adjacent to at least one peripheral edge of the solar energy concentrator;
d) converting the light emitted or collected by the solar energy concentrator to electrical or thermal energy using the energy conversion device; and
e) irradiating plants and/or algae on one or more supports or surfaces in the enclosure with the second wavelength or wavelength band of light.

32. The method of claim 31, characterized in that said energy conversion device comprises a plurality of photovoltaic (PV) cells configured to receive the light emitted or collected by the solar energy concentrator.

33. The method of claim 31, characterized in that the method further comprises absorbing the first wavelength or wavelength band of light with the solar energy concentrator and emitting a third wavelength or wavelength band of light having a longer wavelength than the first wavelength or wavelength band of light from the solar energy concentrator.

34. The method of claim 33, characterized in that the method comprises receiving the light emitted by the solar energy concentrator in the energy conversion device and converting the received light to electrical energy using the energy conversion device.

35. (canceled)

36. The method of claim 31, wherein the structure includes the one or more walls, characterized in that the solar energy concentrator is also on or in at least one of the one or more walls.

37-45. (canceled)

46. The method of claim 31, characterized in that the method further comprises storing thermal energy converted by the energy conversion device in an energy storage and retrieval device or system, retrieving the thermal energy from the energy storage and retrieval device or system, and heating and/or cooling the enclosure (or a part thereof) using the thermal energy from the energy storage and retrieval device or system.

47-49. (canceled)

50. The method of claim 31, characterized in that said absorber(s) or fluorophore(s) comprise one or more organic fluorophores.

51. The method of claim 50, characterized in that said one or more organic fluorophores is/are embedded in a polymer matrix.

52-59. (canceled)

60. The method of claim 50, wherein the fluorophore is bound to or held in association with a binder molecule that increases thermal stability of the fluorophore across a temperature range wider than that of the fluorophore without the binder molecule.

61. The method of claim 50, further comprising protecting the fluorophore with an ultraviolet blocking layer so as to increase fluorophore molecular stability in an environment containing ultraviolet light.
